(19) United States
(12) Patent Application Publication
(10) Pub. No.: US 2022/0056955 A1
(43) Pub. Date: Feb. 24, 2022

(54) BEARING ELEMENTS AND APPARATUS INCLUDING SAME

(71) Applicant: ELEMENT SIX (UK) LIMITED, DIDCOT, OXFORDSHIRE (GB)

(72) Inventors: VALENTINE KANYANTA, DIDCOT (GB); MEHMET SERDAR OZBAYRAKTAR, DIDCOT (GB); MAWEJA KASONDE, DIDCOT (GB)

(73) Assignee: ELEMENT SIX (UK) LIMITED, DIDCOT, OXFORDSHIRE (GB)

(21) Appl. No.: 17/415,337

(22) PCT Filed: Dec. 20, 2019
(86) PCT No.: PCT/EP2019/086756

§ 371 Date: Jun. 17, 2021

(30) Foreign Application Priority Data
Dec. 30, 2018 (GB) 1821299.3

(51) Int. Cl. F16C 33/04; E21B 4/00; F16C 33/10; F16C 33/12; F16C 33/26

(52) U.S. Cl. CPC F16C 33/043; E21B 4/003; F16C 33/108; F16C 2352/00; F16C 33/26; F16C 2206/04; F16C 33/125

(57) ABSTRACT

A bearing element for a bearing assembly has a body of polycrystalline diamond (PCD) material having a bearing contact surface, and a substrate bonded to the body of PCD material along an interface and having a free end surface. The substrate has a through-bore extending longitudinally therethrough, the body of PCD material having a portion extending through the through-bore in the substrate to at least the free end surface thereof, the substrate extending around the peripheral side edge of the portion of PCD material extending therethrough.

### FIELD

This disclosure relates to bearing elements and apparatus including same, for example bearing elements included in thrust or radial bearing assemblies.

### BACKGROUND

Conventional bearing assemblies including bearing surfaces that move relative to one another are well known in the art and are commonly termed “thrust bearings”. In addition, some examples of radial bearings include bearing surfaces that at least partially contact and move or slide relative to one another.

One known application for such bearing assemblies is drilling equipment for use in subterranean drilling applications. For example, conventional downhole drilling equipment may employ radial and/or thrust bearing assemblies. In one example, an inner and outer race are each provided with a plurality of superhard bearing elements. The races are positioned adjacent one another so that the bearing surfaces of the bearing elements contact one another.

The bearing surfaces in such assemblies may include a superhard material for resisting wear during use of the bearing. It is known, for example, for a layer of polycrystalline diamond material (PCD) to form or be included in at least one or both of the bearing surfaces. For example, conventional PCD bearing assemblies may be formed of a PCD disc attached to a substrate such as cemented WC substrate which is brazed into a pocket of a steel base plate to form a PCD thrust bearing assembly as illustrated in FIG. 1.

Although bearing assemblies in which the contact surface of the bearings is formed of PCD material offer better performance compared to other traditional ceramic and steel bearing surfaces and assemblies, PCD material may suffer from thermal degradation due to high temperatures at the contact (bearing) surfaces especially in high speed sliding applications. This may lead to premature or catastrophic failure of conventional PCD bearing systems influencing the performance and life of such a bearing structure. Thus, it would be advantageous to provide improved bearing elements and bearing assemblies including same.

### SUMMARY

Viewed from a first aspect there is provided a bearing element for a bearing assembly comprising:
a body of polycrystalline diamond (PCD) material having a bearing contact surface;
a substrate bonded to the body of PCD material along an interface and having a free end surface; wherein:
   the substrate has a through-bore extending longitudinally therethrough, the body of PCD material having a portion extending through the through-bore in the substrate to at least the free end surface thereof, the substrate extending around the peripheral side edge of the portion of PCD material extending therethrough.

Viewed from a second aspect there is provided an apparatus comprising:
a first plurality of bearing elements, each bearing element of the first plurality having a body of PCD material including a bearing surface, the bearing surfaces of the first plurality of bearing elements defining a first collective bearing surface exhibiting a substantially cylindrical geometry, wherein at least one bearing element of the first plurality of bearing elements includes a body of polycrystalline diamond (PCD) material having a bearing contact surface;
a substrate bonded to the body of PCD material along an interface and having a free end surface; wherein:
the substrate has a through-bore extending longitudinally therethrough, the body of PCD material having a portion extending through the through-bore in the substrate to at least the free end surface thereof, the substrate extending around the peripheral side edge of the portion of PCD material extending therethrough.

In some versions, the above-defined bearing elements are included in a drill bit, a motor or a turbine.

### BRIEF DESCRIPTION OF THE DRAWINGS

Various example bearing assemblies will now be described with reference to the accompanying drawings in which:

FIG. 1 is a perspective view of a part of a support ring into which a plurality of conventional PCD bearing elements are inserted in recesses therein;

FIG. 2 is a schematic cross-sectional view of an example bearing element;

FIG. 3 is a schematic perspective view from above of a support ring into which a plurality of example bearing elements may be inserted in recesses therein;

FIG. 4 is a schematic perspective view from above of a support ring into which a plurality of example bearing elements are inserted in recesses therein;

FIG. 5 is a schematic cross-sectional view of the example bearing element of FIG. 2 brazed into a recess in the support ring of FIGS. 3 and 4;

FIG. 6 is a schematic cross-sectional view of the part of the support ring of FIG. 5 into which an example bearing element is brazed showing the flow of coolant thereover;

FIG. 7 is a schematic cross-sectional view of another example bearing element;

FIG. 8 is a schematic cross-sectional view of the example bearing element of FIG. 2 located in a recess in an alternative support ring to that shown in FIGS. 5 and 6; and

FIG. 9 is a schematic cross-sectional view of a further example bearing element.

### DETAILED DESCRIPTION

The present invention relates generally to bearing apparatuses including bearing surfaces comprising superhard materials. As used herein a “superhard material” is a material having a Vickers hardness of at least about 28 GPa. Diamond and cubic boron nitride (cBN) material are examples of superhard materials.

Polycrystalline diamond (PCD) is an example of a superhard material (also called a superabrasive material or ultra hard material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, due to their function of dissolving, to some extent, the diamond and catalyzing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Most typically, PCD is often formed on a cobalt-cemented tungsten carbide substrate, which provides a source of cobalt solvent-catalyst for the PCD. Materials that do not promote substantial coherent intergrowth between the diamond grains may themselves form strong bonds with diamond grains, but are not suitable solvent—catalysts for PCD sintering.

Cemented tungsten carbide which may be used to form a conventional substrate is formed from carbide particles being dispersed in a cobalt matrix by mixing tungsten carbide particles/grains and cobalt together then heating to solidify. To form the bearing element with a superhard material layer such as PCD, diamond particles or grains are placed adjacent the cemented tungsten carbide body in a refractory metal enclosure and are subjected to high pressure and high temperature so that inter-grain bonding between the diamond grains occurs, forming a polycrystalline superhard diamond layer.

As used herein, polycrystalline diamond (PCD) is a type of polycrystalline superhard (PCS) material comprising a mass of diamond grains, a substantial portion of which are directly inter-bonded with each other.

A “catalyst material” for a superhard material is capable of promoting the growth or sintering of the superhard material.

The term “substrate” as used herein means any substrate over which the superhard material layer is formed. For example, a “substrate” as used herein may be a transition layer formed over another substrate.

As used herein, the term “integrally formed” regions or parts are produced contiguous with each other and are not separated by a different kind of material.

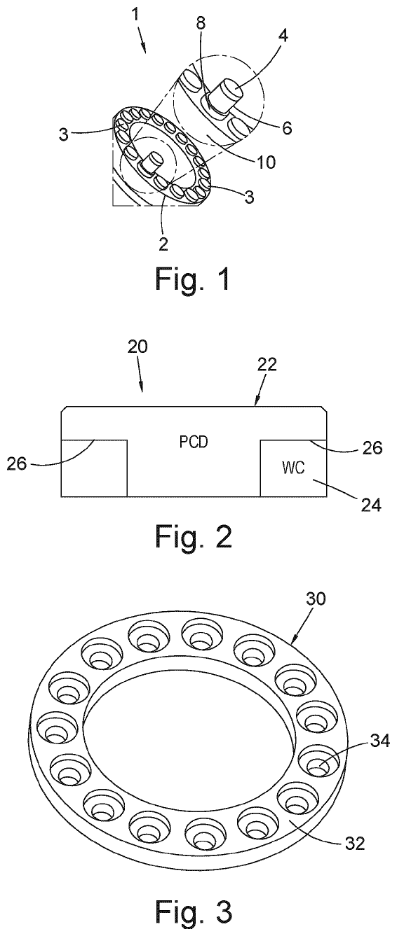

FIG. 1 is a schematic view of a part of a conventional PCD trust bearing assembly 1 having a conventional support ring 2 defining an opening through which a shaft (not shown) of, for example, a down-hole drilling motor may extend. The support ring 2 may be formed of, for example, stainless steel, tungsten carbide or another suitable material. The support ring includes a plurality of recesses 8 formed therein. The thrust bearing assembly 1 further includes a plurality of bearing elements or pads 3 which are located in the recesses 8 spaced around an exposed surface of the support ring 2. The bearing elements are formed of a layer of PCD material 4 of typically 1 mm to 2 mm thickness bonded to a substrate 6 along an interface. The exposed surface of the PCD layer 4 forms the bearing (contact) surface in use. The bearing elements 3 are brazed into the recesses in the support ring via the substrate material 6 which is typically formed of a cemented carbide material such as tungsten carbide.

The exposed top surface of the layer of PCD material 3 opposite the face bonded to the substrate 4 forms the bearing surface face, also known as the contact surface, which is the surface which slides across a corresponding surface in use.

At one end of the substrate 4 is an interface surface that forms an interface with the PCD material layer 3 which is attached thereto at this interface surface. As shown in FIG. 1, the PCD bearing elements may be generally cylindrical and have a peripheral surface 10.

FIG. 2 is an illustration of a first example bearing element 20. The bearing element 20 differs from the conventional elements shown in FIG. 1 in that the body of PCD material 22 which is bonded to the substrate 24 along an interface 26 has a central portion that extends coaxially through the depth of the substrate 24 through a through-bore therein to the free end surface of the substrate opposite the interface surface 26.

In use, a plurality of such example PCD bearing elements 20 may be located recesses 32 in a support ring 30 shown in FIG. 3. The recesses 32 may be shaped to receive a bearing element 20 of FIG. 2 such that the free end surface of the substrate 24 which encircles the central portion of the body of PCD material 22 extending therethrough abuts a flange portion extending across the base of the recess into which the element is to be retained leaving the free end surface of the body of PCD material of the central portion which is coplanar with said surface of the substrate 24 is exposed through an aperture 34 in the base of the recess 32. The free end surface of the substrate 24 which abuts the flange in the recess 32 in the support ring 30 may be brazed thereto using a conventional braze technique.

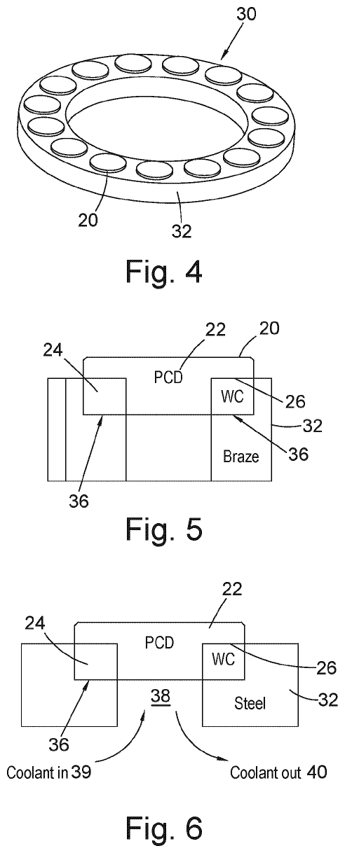

FIG. 4 shows a plurality of example bearing elements brazed into the recesses in the support ring 30 of FIG. 3 and FIG. 5 is a schematic cross-sectional view of the example bearing element of FIG. 2 brazed into a recess in the support ring 30 of FIGS. 3 and 4 with the braze material 36 being located across the flange in the recess 32 that abuts and brazes the free end surface of the substrate 24.

FIG. 6 is a schematic cross-sectional view of the part of the support ring of FIG. 5 into which an example bearing element is brazed showing the flow of coolant thereover in an end application. In particular, the exposed free end of the central portion of the body of PCD material 22 extending through the substrate 24 which is coplanar with said surface of the substrate 24 brazed to the flange of the support ring 30 and which is exposed through an aperture in the base of the recess 32 is spaced from the base surface of the support ring 30 creating a recess (or cooling channel) 38 into which a coolant 39 may flow in use and out of which the coolant may flow. As PCD material is a good thermal conductor, heat created on the contact surface of the body of PCD material may be conducted through the body of PCD material and dissipated through the coolant 40 flowing out of the recess 38.

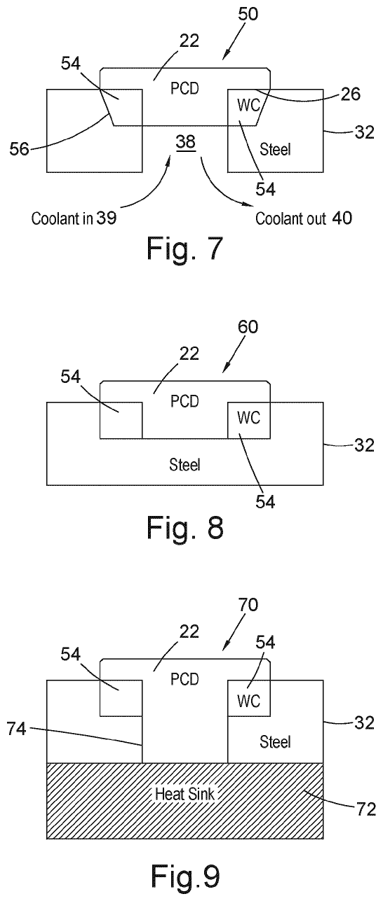

A further example bearing element 50 is shown in FIG. 7 located in a recess 32 in the support ring. This example differs from that shown in FIG. 2 in that the substrate 54 peripherally encircling the central portion of the PCD material 22 extending therethrough has a peripheral side surface 56 that is tapered towards the free end surface of the substrate such that the portion of the substrate retained in the support ring has a frustroconical shape with a throughbore therethrough and through which the PCD material extends. The recess in the support ring receiving the substrate of the bearing element 50 is corresponding tapered to abut the peripheral side surface of the substrate 54. The body of PCD material 22 may be cooled in the same way as that of the example of FIG. 6.

A still further example of a PCD bearing element 60 is shown in FIG. 8. This example differs from that shown in FIGS. 2, 5 and 6 in that the recess 32 in the support ring 30 is formed without the additional aperture therein which, in the example of FIGS. 2, 5 and 6, exposes the free end surface of the central portion of the body of PCD material that extends through the substrate 54 to a coolant. By contrast, in the example of FIG. 8, this free end surface of the central portion of the body of PCD material contacts the surface in the support ring that defines the base of the recess 32 therein. In this example, heat created on the contact surface of the body of PCD material may be conducted through the body of PCD material and dissipated through the material of the support ring.

A further example of a PCD bearing element 70 is shown in FIG. 9. In this example, the central portion 74 of the body of PCD material extending through the substrate 54 extends beyond the free end surface of the substrate that is brazed to the support ring and it extends through the support ring to the base surface of the support ring such that it is coplanar with said surface. The base surface of the support ring may be arranged to contact a body of material 72 which acts as a heat sink conducting heat away from the body of PCD material through its contact therewith via the central portion 74 which is in directed contact with the heat sink material 72.

In each of the example bearing elements 20, 50, 60 and 70, the body of polycrystalline diamond (PCD) material may be formed of diamond grains having natural or synthetic origin.

The example substrates 24, 54 may be formed of a cemented carbide material such as WC. In some examples, the cemented carbide material forming the substrate 10 may comprise at least 0.1 wt. % of any one or more of Ti, V, Cr, Mn, Zr, Si, Nb, Mo, Hf, and/or Ta, for example a carbide, nitride and/or carbonitride thereof.

In some examples, the substrate 24, 54 may further comprise at least around 0.2 wt. % of any one or more of Co, Fe and/or Ni.

The bearing elements of the examples shown in FIGS. 2, and 4 to 9 may be fabricated, for example, as follows.

To form an example substrate 24, 54, a fine WC powder with a WC mean grain size of about 0.8 μm was sintered by a conventional spark plasma sintering (SPS) technique. The sintering conditions may be, for example, as follows: a heating rate of 50°/min from room temperature up to 1500° C., at a pressure of 50 MPa, for a sintering time of 5 min at 1500° C., in a sintering atmosphere of Ar.

After the sintering process the substrate was ground to the required size for use as substrates for the example PCD bearing constructions. In some examples the throughbore in the substrate into which the body of PCD material extends is formed after sintering using conventional techniques such as EDM, laser ablation or the like. In other examples, the throughbore is creating in situ during the sintering process by placing an appropriately shaped plug or punch in the WC powder prior to sintering which is removed after sintering the substrate.

The pre-formed substrates were then loaded into cups and a diamond mix powder was introduced into the cups on top of the substrates to form a pre-composite, the diamond powder extending through the through bore in the substrate. In some examples, the diamond powder mixtures were placed into the cups and substrates placed on top of the powders. The pre-composites were then sintered under HPHT at a temperature of at least about 1400 degrees C., and a pressure of around 7.7 GPa to form example PCD constructions comprising a body of PCD material bonded to a substrate.

After sintering, the PCD bearing elements were ground to the required size for use as the example bearing elements.

In the example bearing elements, the body of PCD material may comprise a PCD region that is continuous throughout the entire thickness of the PCD material and the substrate forms a ring around a central portion thereof providing a mechanism of brazing the bearing element into the support ring which may typically be formed of steel.

Whilst not wishing to be bound by a particular theory it is believed the example bearing elements and bearing assemblies including the support ring into which the example bearing elements are inserted may provide an exposed PCD surface at the back-end of the assembly to facilitate the conducting heat away from the PCD bearing (contact) surface to reduce the temperature at the bearing contact surfaces that slide over corresponding surfaces in a corresponding bearing assembly and thereby improve the overall performance of PCD bearing assembly.

As shown in FIGS. 3 and 4, the support ring 30 may be configured in a generally ring-shaped or toroid-shaped configuration and may define a central aperture which is generally centred about a longitudinal axis. The recesses 32 in the support ring 30 may each be positioned at substantially the same radius and may be substantially equally circumferentially spaced in the support ring with respect to one another in relation to the longitudinal axis thereof.

In use, the body of PCD material of the bearing elements includes a bearing surface and may optionally include a chamfer. The bearing surface of each element may be substantially planar and may be configured to contact another bearing element (e.g., a bearing element coupled to a rotor) including another bearing surface that corresponds to bearing surface of the bearing element.

As known in the art, polycrystalline diamond may include a catalyst (e.g., cobalt, nickel, iron, or any other catalyst as known in the art) to facilitate formation of polycrystalline diamond. Optionally, at least a portion of a catalyst within the body of PCD material of the example bearing elements may be removed (e.g., by acid leaching or as otherwise known in the art).

The support ring with the bearing elements retained therein may be affixed to a system to provide a thrust bearing structure. In further examples, the support ring may be configured to retain a plurality of bearing elements that may be coupled to the body of an outer race so that each bearing surface of the bearing elements collectively form a bearing surface for a radial bearing apparatus.

Such a radial bearing apparatus may be advantageous because of its ability to withstand relatively high temperatures and its wear resistance. Accordingly, it is contemplated that a radial bearing apparatus may be cooled by a drilling fluid (i.e., a drilling mud) used to carry cuttings from a leading end of a bore hole upward to the surface of a subterranean formation, as known in the art.

Furthermore, the bearing apparatuses disclosed above may be incorporated into a mechanical system and generally such a bearing apparatus including a plurality of example polycrystalline diamond bearing elements may be arranged to define a plurality of surfaces that contact corresponding surfaces of a bearing elements in a corresponding support ring that move relative to one another. Such bearing apparatuses may encompass so-called thrust bearings, radial bearings, or other bearing apparatuses including bearing surfaces that move in relation to one another, without limitation.

As mentioned above, the bearing apparatuses disclosed above may be incorporated into any suitable mechanical system. Any other suitable rotary drill bit or drilling tool may include a radial bearing apparatus according to the examples, without limitation.

Further, in another example, a radial bearing according to the examples may be included within a motor or turbine including a wind turbine. Therefore, although the apparatuses and systems described above have been discussed in the context of subterranean drilling equipment and applications, it should be understood that such apparatuses and systems are not limited to such use and could be used within a bearing apparatus or system for varied applications, if desired, without limitation. Thus, such apparatuses and systems are not limited to use with subterranean drilling systems and may be used with various other mechanical systems, without limitation.

1. A bearing element for a bearing assembly comprising:
a body of polycrystalline diamond (PCD) material having a bearing contact surface;
a substrate bonded to the body of PCD material along an interface and having a free end surface; wherein:
the substrate has a through-bore extending longitudinally therethrough, the body of PCD material having a portion extending through the through-bore in the substrate to at least the free end surface thereof, the substrate extending around the peripheral side edge of the portion of PCD material extending therethrough.

2. The bearing element of claim 1, wherein the portion of the PCD material extending through the substrate extends beyond the free end surface of the substrate.

3. The bearing element of claim 1, wherein the substrate tapers towards the free end surface thereof.

4. The bearing element of claim 3, wherein the substrate has a frustroconical portion defined by the taper towards the free end surface.

5. The bearing element of claim 1, wherein the bearing contact surface is substantially planar.

6. The bearing element of claim 1, wherein the substrate comprises a cemented tungsten carbide material.

7. A bearing assembly comprising a support ring, and a plurality of the bearing elements according to claim 1, the bearing elements each being retained in a respective recess in the support ring.

8. The bearing assembly of claim 7, wherein the support ring is shaped to define one or more of the recesses therein to expose the free end surface of the portion of PCD material extending through the substrate of the bearing element retained therein.

9. The bearing assembly of claim 7, wherein the support ring is shaped to define one or more of the recesses therein as having a portion contacting the free end surface of the portion of PCD material extending through the substrate of the bearing element retained therein.

10. The bearing assembly of claim 7, further comprising a heat sink element abutting the support ring along an interface opposite the surface into which the plurality of bearing elements are inserted, the free end surface of the portion of PCD material extending through the substrate of the bearing element(s) retained therein being arranged to contact the heat sink element along the interface.

11. An apparatus comprising:
a first plurality of bearing elements, each bearing element of the first plurality having a body of PCD material including a bearing surface, the bearing surfaces of the first plurality of bearing elements defining a first collective bearing surface exhibiting a substantially cylindrical geometry, wherein at least one bearing element of the first plurality of bearing elements includes a body of polycrystalline diamond (PCD) material having a bearing contact surface;
a substrate bonded to the body of PCD material along an interface and having a free end surface; wherein:
the substrate has a through-bore extending longitudinally therethrough, the body of PCD material having a portion extending through the through-bore in the substrate to at least the free end surface thereof, the substrate
extending around the peripheral side edge of the portion of PCD material extending therethrough.

12. The apparatus of claim 11, further comprising a second plurality of bearing elements, each bearing element of the second plurality having an individual bearing surface, wherein the plurality of individual bearing surfaces of the second plurality of bearing elements define a second collective bearing surface configured for contact with the first collective bearing surface.

13. The apparatus of claim 12, further comprising a first body and a second body, wherein each of the first plurality of bearing elements is at least partially disposed within an associated one of a plurality of recesses of the first body, and wherein each of the second plurality of bearing elements is at least partially disposed within an associated one of a plurality of recesses of the second body.

14. The apparatus of claim 12, wherein the first body is substantially ring-shaped and wherein the plurality of recesses of the first body are located in a surface of the first body.

15. The apparatus of claim 14, wherein the first body is substantially ring-shaped and wherein the plurality of recesses of the first body are located in a radial inner or outer surface of the first body, the bearing apparatus forming a radial bearing apparatus.

16. The apparatus of claim 14, wherein the first body is substantially ring-shaped and wherein the plurality of recesses of the first body are located in a first surface of the first body, the bearing apparatus forming a thrust bearing apparatus.

17. The apparatus of claim 11, wherein the plurality of bearing elements are included in a drill bit, a motor or a turbine.
